(19) United States
(12) Patent Application Publication
(10) Pub. No.: US 2011/0261167 A1
(43) Pub. Date: Oct. 27, 2011

(54) THREE-DIMENSIONAL CAMERA APPARATUS

(75) Inventor: Doo-Sik SHIN, Suwon-si (KR)

(73) Assignee: Samsung Electronics Co., Ltd., Suwon-si (KR)

(21) Appl. No.: 13/091,638

(22) Filed: Apr. 21, 2011

(30) Foreign Application Priority Data
Apr. 21, 2010 (KR) 10-2010-0037092

(51) Int. Cl. H04N 13/02

(52) U.S. Cl. 348/47; 348/E13.074

(57) ABSTRACT

A three-dimensional (3D) camera apparatus is provided which includes a first camera module and a second camera module, which are folded or unfolded through rotation and horizontally move in the unfolded state to adjust a distance therebetween. The 3D camera apparatus includes a camera housing, the first camera module and the second camera module which are rotatably or movably coupled to the camera housing, are folded to or unfolded from the camera housing through rotation, and horizontally move in the unfolded state to adjust a distance there between. A driving unit is provided in the camera housing to allow rotation or horizontal movement of the first camera module and the second camera module, and a guide movement portion provided in the camera housing to guide horizontal movement of the first camera module and the second camera module.

### PRIORITY

This application claims priority under 35 U.S.C. §119(a) to a Korean Patent Application filed in the Korean Intellectual Property Office on Apr. 21, 2010 and assigned Serial No. 10-2010-0037092, the contents of which are hereby incorporated by reference.

### BACKGROUND OF THE INVENTION

1. Field of the Invention

The present invention relates to a three-dimensional (3D) camera apparatus by which a first camera module and a second camera module are folded or unfolded through rotation and horizontally move in the unfolded state to adjust a distance therebetween.

2. Description of the Related Art

Generally, a “three-dimensional (3D) stereoscopic image” refers to an image in which depth and space formation information of a two-dimensional (2D) image are added to apply a stereoscopic effect to an object in the image.

The stereoscopic effect is generated by a disparity between a left-view image and a right-view image perceived by a human's two eyes, and the human perceives the images as a 3D stereoscopic image through the human brain's synthesis process of combining the two images. The cubic effect uses the generation of parallax between the eyes due to a distance of about 65 mm between the eyes when the eyes see the images oriented in two slightly different directions.

To capture a 3D stereoscopic image, two interworking cameras are required. When a conventional portable communication device has one camera module like a digital camera, a side image is captured and then another-side image is captured and they are synthesized to acquire a 3D image. However, if an object moves due to a difference between two capturing times, a desired 3D image cannot be acquired and a capturing region cannot remain the same, making it difficult to acquire the 3D image.

A conventional 3D camera apparatus includes a fixed 3D camera apparatus, which fixes a distance between two cameras and an adjustable 3D camera apparatus, which adjusts the distance between the two cameras.

As an object moves near, parallax between the two cameras' lenses increases, together with an increase of a non-overlapping region at an outer side of each of 3D captured regions of left and right captured screens. The non-overlapping region has an image loss, making it difficult to see.

The variable 3D camera apparatus developed to solve the foregoing image loss problem reconciles visual systems of left and right camera lenses in terms of in-focus distance, thereby achieving an excellent 3D effect while solving the image loss caused by the non-overlapping region.

As shown in FIG. 1, a conventional variable 3D camera apparatus 1 adjusts a distance between cameras and includes a lens housing 2, two cameras 3 and 4 which horizontally move to the left or to the right in the lens housing 2, and a lens adjusting unit 5 which adjusts a distance between the cameras 3 and 4 by horizontally moving the cameras 3 and 4.

The lens adjusting unit 5 includes a gear portion 6 mounted on the cameras 3 and 4 and a motor 7 which rotates the gear portion 6.

However, the variable 3D camera apparatus 1 has to provide space to allow horizontal movement of the cameras 3 and 4 in the lens housing 2, limiting the space utilization of a product and hindering the slimness and miniaturization of the product due to size increase.

As shown in FIG. 2, the cameras 3 and 4 of the conventional variable 3D camera apparatus 1 include a plurality of camera lenses 3a and 4a, a plurality of prisms 3b and 4b for refracting an optical axis direction D1, and a plurality of image sensors 3c and 4c, respectively.

However, the prisms 3b and 4b have to be precisely mounted in the cameras 3 and 4 along the optical axis direction D1, increasing the time required for the assembly process of the product and thus limiting the assembly efficiency of the product.

Therefore, there is a need for an 3D camera apparatus which folds or unfolds cameras by rotating to allow other parts to be mounted in a movement space provided in a camera and horizontally moves the cameras to adjust a distance between the cameras in the unfolded state.

### SUMMARY OF THE INVENTION

An aspect of the present invention is to address at least the above problems and/or disadvantages and to provide at least the advantages described below. Accordingly, an aspect of the present invention is to provide a 3D camera apparatus by which a first camera module and a second camera module are folded or unfolded through rotation and horizontally move in the unfolded state to adjust a distance therebetween, allowing a plurality of other parts of the camera modules to be mounted in a movement space provided in a product and thus improving the space utilization of the product.

Another aspect of the present invention is to provide a 3D camera apparatus by which a first camera module and a second camera module are folded or unfolded through rotation and horizontally move in the unfolded state to adjust a distance therebetween, thereby removing a need for a movement space provided in an existing product and thus achieving a thinner and smaller product.

Moreover, another aspect of the present invention is to provide a 3D camera apparatus in which a plurality of camera lenses and a plurality of image sensors, without a plurality of prisms which have to be precisely mounted, are arranged along an optical axis, thereby improving the assembly precision and efficiency of the assembly process of a product and thus reducing an assembly time of the product.

According to an aspect of the present invention, there is provided a three-dimensional (3D) camera apparatus including a camera housing, a first camera module and a second camera module which are rotatably or movably coupled to the camera housing, are folded to or unfolded from the camera housing through rotation, and horizontally move in the unfolded state to adjust a distance therebetween, a driving unit provided in the camera housing to allow rotation or horizontal movement of the first camera module and the second camera module, and a guide movement portion provided in the camera housing to guide horizontal movement of the first camera module and the second camera module.

### BRIEF DESCRIPTION OF THE DRAWINGS

The above and other features and advantages of the present invention will be more apparent from the following detailed description taken in conjunction with the accompanying drawings, in which:

FIG. 1 is a perspective view showing a conventional 3D camera apparatus;

FIG. 2 is a cross-sectional view of a camera of a conventional 3D camera apparatus;

FIG. 3 is a perspective view showing a before-operation state of a protection cover portion of a 3D camera apparatus according to an embodiment of the present invention;

FIG. 4 is a perspective view showing an after-operation state of a protection cover portion of a 3D camera apparatus according to an embodiment of the present invention;

FIG. 5 is a perspective view showing a state after rotation of a first camera module and a second camera module of a 3D camera apparatus according to an embodiment of the present invention;

FIG. 6 is a perspective view showing a state where a first camera module and a second camera module of a 3D camera apparatus horizontally move in an unfolded state according to an embodiment of the present invention;

FIG. 7 is an enlarged perspective view of portion A of FIG. 6;

FIG. 8 is a perspective view showing a before-operation state of a 3D camera apparatus according to an embodiment of the present invention; and

FIG. 9 is a side view of a first camera module and a second camera module of a 3D camera apparatus according to an embodiment of the present invention.

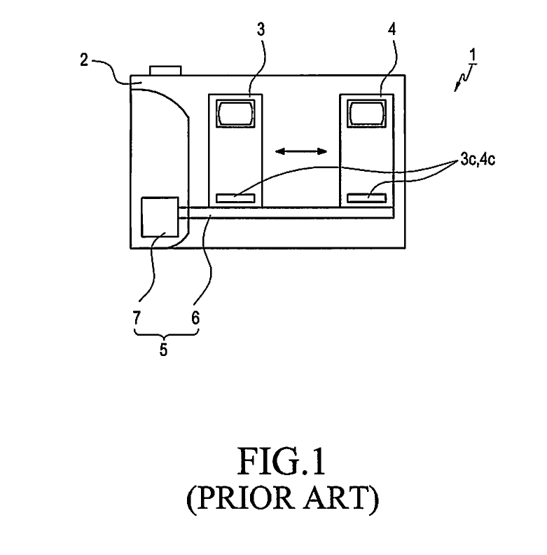

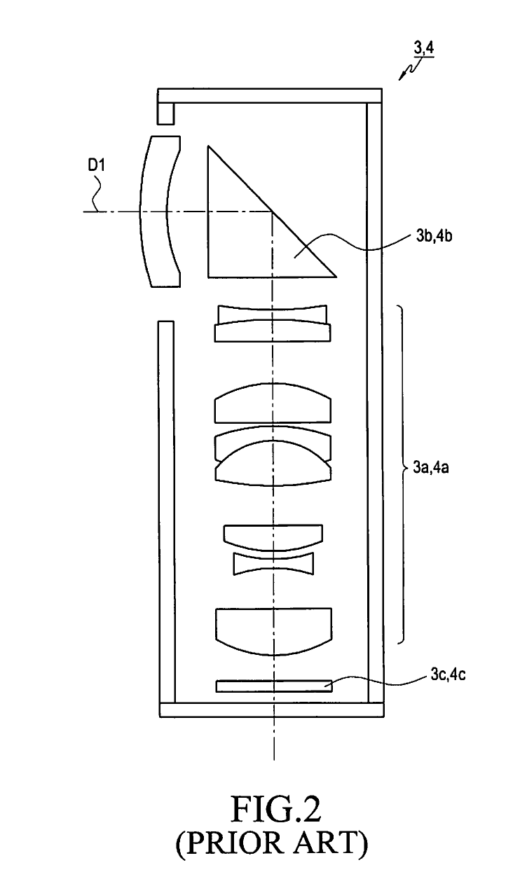

### DETAILED DESCRIPTION OF EMBODIMENTS OF THE PRESENT INVENTION

Embodiments of the present invention will be described in detail with reference to the accompanying drawings. The embodiment disclosed in the specification and structures shown in the drawings are merely exemplary of the present invention, and it should be understood that variations capable of substituting for the embodiment may exist at the time of filing the application.

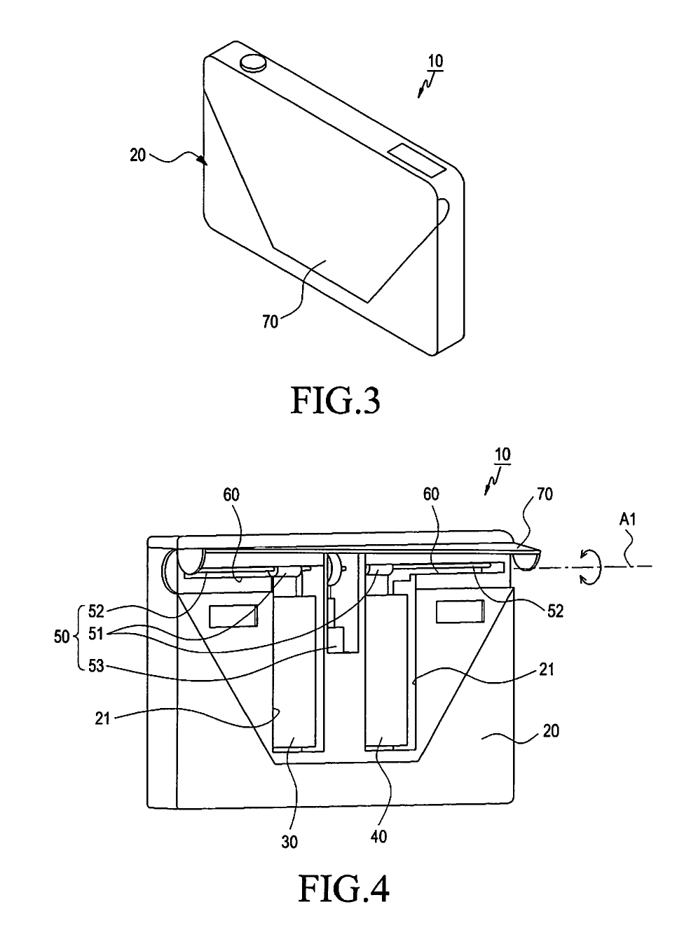

As shown in FIGS. 3 through 9, a three-dimensional (3D) camera apparatus 10 includes a camera housing 20, a first camera module 30, a second camera module 40, a driving unit 50, and a guide movement portion 60. The camera housing 20 includes the first camera module 30, the second camera module 40, the driving unit 50, and the guide movement portion 60. The first camera module 30 and the second camera module 40 are rotatably or movably coupled to the camera housing 20, such that the first camera module 30 and the second camera module 40 are folded to, or unfolded from, the camera housing 20 by rotating around a rotation axis A1, and horizontally move in the unfolded state to adjust a distance therebetween. The driving unit 50 is provided in the camera housing 20 to allow the first camera module 30 and the second camera module 40 to rotate or horizontally move. The guide movement portion 60 is provided in the camera housing 20 to guide horizontal movement of the first camera module 30 and the second camera module 40.

As shown in FIGS. 3 through 7, the camera housing 20 is provided with a protection cover portion 70, which rotates from a closed state to an open state, and vice versa, and in the closed state protects the first camera module 30, the second camera module 40, the driving unit 50, and the guide movement portion 60.

As shown in FIGS. 4 through 7, in the camera housing 20 are formed insertion/ejection movement grooves 21 which allow the first camera module 30 and the second camera module 40 to be inserted into or ejected from the camera housing 20 when being folded or unfolded by rotation and to horizontally move in the ejected state. The injection/ejection movement grooves 21 are in the shape of an “L”.

As shown in FIGS. 4 through 7, the driving unit 50 includes first gear portions 51, second gear portions 52, and a driving motor 53. The first gear portions 51 are provided on an end portion of the first camera module 30 and an end portion of the second camera module 40 to be rotatably engaged with the second gear portions 52 and to allow rotation or horizontal movement of the first camera module 30 and the second camera module 40. The second gear portions 52 are provided in the camera housing 20 and are engaged with the first gear portions 51 to allow rotation or horizontal movement of the first gear portions 51 by rotating together with rotation of the driving motor 53. The driving motor 53 is provided in the camera housing 20 to rotate the second gear portions 52 by rotating upon receipt of power from a power supply (not shown).

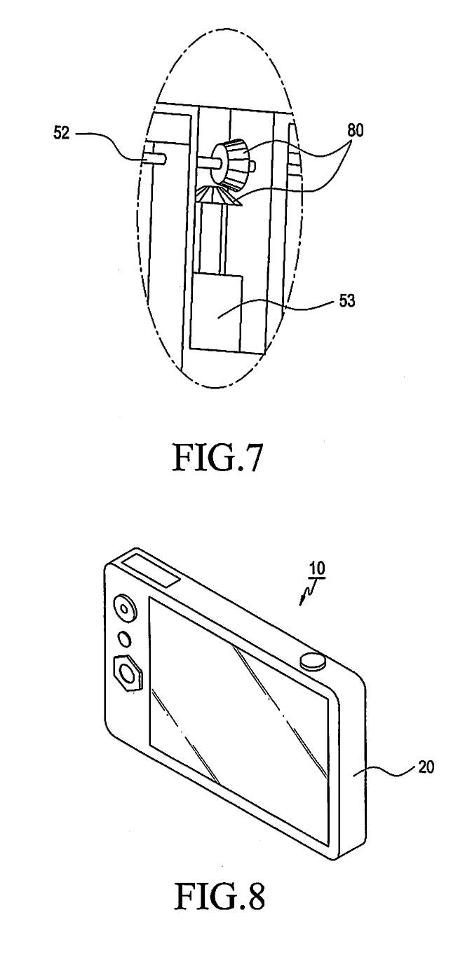

As shown in FIG. 7, the second gear portions 52 and the driving motor 53 are provided with bevel gears 80 to transfer rotation of the driving motor 53 to the second gear portions 52.

As shown in FIGS. 4 through 6, the guide movement portion 60 includes a guide groove to allow horizontal movement of the first camera module 30 and the second camera module 40.

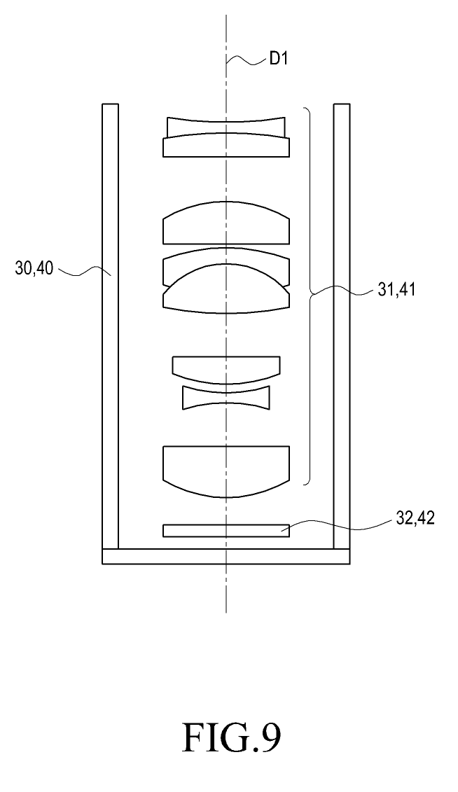

As shown in FIG. 9, the first camera module 30 and the second camera module 40 include a plurality of camera lenses 31 and 41 and a plurality of image sensors 32 and 42 along an optical axis direction D1 without conventional prisms.

The 3D camera apparatus according to an embodiment of the present invention is applicable to a digital camera as a representative example. However, the 3D camera apparatus may also be applied to various types of terminals such as a portable communication device, without being limited to a digital camera.

Examples of the digital camera or the portable communication device according to the present invention may include not only mobile communication terminals operating according to communication protocols corresponding to various communication systems, but also any information communication apparatuses and multimedia apparatuses such as Portable Multimedia Players (PMPs), MP3 players, game players, notebooks, advertisement boards, TVs, digital broadcasting players, Personal Digital Assistants (PDAs), smart phones, and so forth, and their application apparatuses.

With reference to FIGS. 3 through 9, a detailed description will be made of an operation process of the 3D camera apparatus according to an embodiment of the present invention.

As shown in FIGS. 3 through 9, the 3D camera apparatus 10 includes the camera housing 20, the first camera module 30, the second camera module 40, the driving unit 50, and the guide movement portion 60.

As shown in FIGS. 4 through 7, the second gear portions 52 of the driving unit 50 are installed in the insertion/ejection movement grooves 21 formed in the camera housing 20, and the first gear portions 51 provided on the end portions of the first camera module 30 and the second camera module 40 are rotatably engaged with the second gear portions 52.

The driving motor 53 is provided in a center portion of the camera housing 20, and is engaged with the second gear portions 52 by means of the bevel gears 80.

The protection cover portion 70 is rotatably provided in the camera housing 20.

In this state, as shown in FIGS. 4 through 7, to capture a 3D image by using the 3D camera apparatus 10, a user first opens the protection cover portion 70 provided in the camera housing 20 by rotating the protection cover portion 70.

At this time, power is applied to the driving motor 53 to rotate the driving motor 53, and the driving motor 53 then rotates the second gear portions 52 by means of the bevel gears 80.

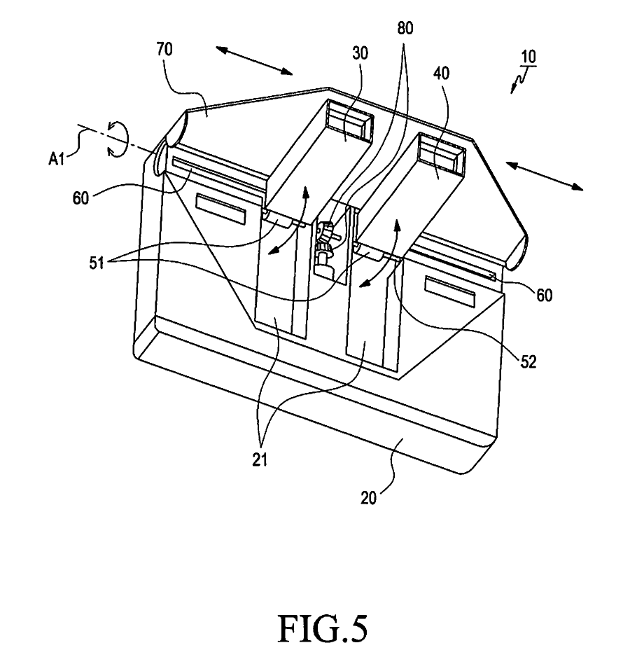

In this case, as shown in FIG. 5, the second gear portions 52 rotate the first gear portions 51 around a rotation axis A1 and eject the first camera module 30 and the second camera module 40 from the insertion/ejection movement grooves 21.

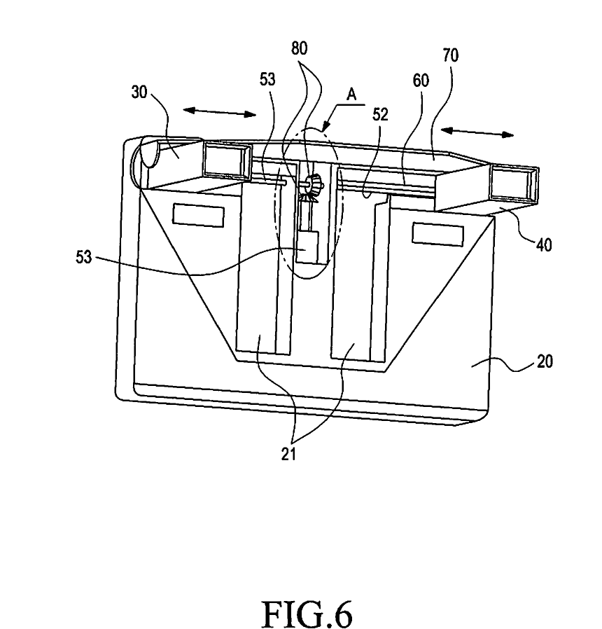

As shown in FIG. 6, when the first camera module 30 and the second camera module 40 are ejected, the second gear portions 52 are rotated again by the driving motor 53, such that the first gear portions 51 move and the first camera module 30 and the second camera module 40 also horizontally move to the left or to the right.

In this state, a distance between the first camera module 30 and the second camera module 40 can be adjusted.

As such, by adjusting the distance between the first camera module 30 and the second camera module 40, the visual systems of the camera lenses 31 and 41 provided in the first camera module 30 and the second camera module 40 can reconcile the separate images, thereby solving an image loss problem caused by a non-overlapping region and providing a clear 3D image.

Moreover, other parts, for example, the driving motor 53, of the 3D camera apparatus 10 can be mounted in a movement space provided in the camera housing 20, thereby improving the space utilization of a product.

Furthermore, as shown in FIG. 9, the first camera module 30 and the second camera module 40 include the plurality of camera lenses 31 and 41 and the plurality of image sensors 32 and 42 along the optical axis direction D1, without separate prisms, thereby removing a need for the assembly process of the prisms and thus improving the precise and efficient assembly process of the product.

Herein, as shown in FIGS. 3 and 8, to return the first camera module 30 and the second camera module 40 back to their original positions, the user supplies power to the driving motor 53 to rotate the driving motor 53, which then rotates the second gear portions 52 by means of the bevel gears 80.

In this state, as shown in FIG. 6, the second gear portions 52 move the first gear portions 51, and the first camera module 30 and the second camera module 40 horizontally move back to their original positions.

As shown in FIG. 5, once the driving motor 53 is rotated again to rotate the second gear portions 52, the first gear portions 51 are also rotated and the first and second camera modules 30 and 40 are also rotated, such that the ejected first camera module 30 and second camera module 40 are inserted into the insertion/ejection movement grooves 21.

In this state, the protection cover portion 70 is rotated to close the camera housing 20.

While the present invention has been shown and described with reference to certain embodiments thereof, it will be understood by those skilled in the art that various changes in form and details may be made therein without departing from the spirit and scope of the invention as defined by the appended claims.

What is claimed is:

1. A three-dimensional (3D) camera apparatus comprising:
a camera housing;
a first camera module and a second camera module which are rotatably or movably coupled to the camera housing, are folded to or unfolded from the camera housing through rotation, and horizontally move in the unfolded state to adjust a distance therebetween;
a driving unit provided in the camera housing to allow rotation or horizontal movement of the first camera module and the second camera module; and
a guide movement portion provided in the camera housing to guide horizontal movement of the first camera module and the second camera module.

2. The 3D camera apparatus of claim 1, wherein the camera housing is provided a protection cover portion, which rotates from a closed state to an open state and in the closed state protects the first camera module, the second camera module, the driving unit, and the guide movement portion.

3. The 3D camera apparatus of claim 1, wherein the camera housing includes insertion/ejection movement grooves which allow the first camera module and the second camera module to be inserted into or ejected from the camera housing when the first camera module and the second camera module are folded or unfolded through rotation and to horizontally move when the first camera module and the second camera module are ejected.

4. The 3D camera apparatus of claim 3, wherein the insertion/ejection movement grooves are in the shape of an “L”.

5. The 3D camera apparatus of claim 1, wherein the driving unit comprises:
first gear portions provided on an end portion of the first camera module and an end portion of the second camera module;
second gear portions provided in the camera housing to be engaged with the first gear portions and to allow rotation or horizontal movement of the first gear portions by rotating together with rotation of a driving motor; and
wherein the driving motor is provided in the camera housing.

6. The 3D camera apparatus of claim 5, wherein the second gear portions and the driving motor comprise bevel gears to transfer rotation of the driving motor to the second gear portions.

7. The 3D camera apparatus of claim 1, wherein the guide movement portion comprises a guide groove.

8. The 3D camera apparatus of claim 1, wherein the first camera module and the second camera module comprise a plurality of camera lenses and a plurality of image sensors along an optical axis.
